(19) United States
(12) Patent Application Publication
(10) Pub. No.: US 2026/0186387 A1
(43) Pub. Date: Jul. 2, 2026

(54) QUICK MOUNTING MECHANISM FOR A SUPPORTING SYSTEM

(71) Applicant: Guangdong Sirui Optical Co., Ltd., Zhongshan (CN)

(72) Inventors: Jie Li, Zhongshan (CN); Fan Xiao, Zhongshan (CN)

(73) Assignee: Guangdong Sirui Optical Co., Ltd., Zhongshan (CN)

(21) Appl. No.: 19/004,332

(22) Filed: Dec. 29, 2024

(30) Foreign Application Priority Data
Dec. 19, 2023 (CN) 202323478156.4

(51) Int. Cl. G03B 17/56; F16M 11/04

(52) U.S. Cl. CPC G03B 17/561; F16M 11/041

(57) ABSTRACT

A quick-mount mechanism includes a base, a movable block, a locking block, a quick-mount seat and a lever assembly. The movable block and the locking block enclose a dovetail groove at the front of the base. One end of the movable block is rotatably connected to a rotating shaft of the base, and the movable block rotates in a direction responsive under an action of a torsion-spring. The locking block is movably installed on one side of the base, and the lever assembly includes a tension rod and a lever. When the lever is in a released position, the quick-mount seat moves into the dovetail groove from the front of the base. When the lever is in locked, the lever pushes the locking block to move closer to the movable block, so that the locking block and the movable block may lock the quick-mount seat in the dovetail groove.

### CROSS-REFERENCE TO RELATED APPLICATIONS

This application claims the priority of prior filed Chinese applications with application numbers 202323478156.4, and 202311758075.1, both filed on Dec. 19, 2023, whose disclosures are incorporated by reference in their entirety herein.

### TECHNICAL FIELD

Aspects of the invention generally relate to photographic equipment. In particular, embodiments of the invention relate to a quick mounting mechanism or device.

### BACKGROUND

The quick-mount mechanism on the traditional gimbal includes a panel base, a quick-mount seat and a lever locking mechanism. The panel base may include a sliding groove for the quick-mount seat to typically slide horizontally along the slide groove to have the quick-mount seat installed. When the quick-mount seat slides horizontally into place, the quick-mount seat is restricted by the slide groove of the lever locking mechanism. When the quick-mount seat is installed, the quick-mount seat can only slide horizontally along the slide groove of the panel base. However, the quick-mount seat cannot be quickly installed from top to bottom, resulting in a long installation time for the quick-mount seat. For photographers, some important photographic images may be missed during the assembly process of the long quick-mount seat, affecting the photography experience.

In order to facilitate the quick-mount seat to be quickly installed on the panel base from top to bottom, some quick-mount mechanisms are provided with a sliding block on the back of the panel base, and a locking block is rotatably connected to one side of the sliding block. The lever is connected to the side of the sliding block facing away from the locking block and can drive the movable block to slide. The reset spring is elastically arranged between the sliding block and the panel base. The lever locking mechanism has a locked state and a unlocked state during the rotation process. When the lever locking mechanism is in the locked state, the sliding block moves to one side of the lever locking mechanism, the reset spring is compressed, and the sliding block drives the locking block to lock the quick-mount seat in the slot. When the lever is in the unlocked state, the reset spring drives the sliding block and the locking block to move in the direction of unlocking the quick-mount seat. At this time, the quick-mount seat is loosened and can be removed from the slot of the panel base.

The locking force actually applied by the locking block on the quick-mount seat may be slightly smaller than the locking force applied by the lever locking mechanism, thus affecting the locking effect of the quick-mount seat. In addition, the sliding block is horizontally slidably arranged on the back of the panel base, and a baffle and a locking screw are required to additionally limit the sliding block to the panel base. Many parts need to be arranged, the overall structure is relatively complex, and the production cost is high.

### SUMMARY

Therefore, aspects of the invention may solve technical problems by overcoming the defects of the quick mechanism of the prior art quick-mount seat with poor locking effect and complex locking structure and components. Embodiments of the invention may quickly install from top to bottom, thereby providing a quick-mount mechanism.

Embodiments of the invention attempt to solve the above technical problems with the following features:

In one embodiment, a quick-mount mechanism comprises a base, a movable block, a locking block, a quick-mount seat and a lever assembly. In some embodiments, the movable block and the locking block may be respectively located at opposite sides of the base. In some embodiments, the movable block and the locking block cooperate to enclose a dovetail groove at the front side of the base. In some embodiments, a rotating shaft may be installed on a back side of the base, and one end of the movable block may be rotatably connected to the rotating shaft. A torsion spring may be wound on the rotating shaft, and one end of the torsion spring abuts against the base. In some embodiments, the other end abuts against the movable block, and an elastic force of the torsion spring may drive the movable block to rotate in a direction of a pressing force on the base.

In some embodiments, the locking block may be movably installed on one side of the base along the connection direction of the locking block and the movable block, The quick-mount seat may be detachably connected to the dovetail groove. In some embodiments, the lever assembly may include a tension rod connected to the base at one end and penetrating the locking block, and a lever located on the side of the locking block facing away from the base and rotatably connected to the end of the tension rod. The lever may, in some embodiments, include a locked position and a released position during rotation. In some embodiments, when the lever is in the released position, the quick-mount seat may be pressed into the dovetail groove from the front of the base. In some embodiments, when the lever is in the locked position, the lever may push the locking block to move toward the movable block, so that the locking block and the movable block cooperate to lock the quick-mount seat in the dovetail groove.

Furthermore, the movable block may include a movable block inclined surface forming one groove side wall of the dovetail groove, and the locking block may include a locking block inclined surface forming another groove side wall of the dovetail groove. In some embodiments, one side of the quick-mount seat may include a first inclined surface matching with the inclined surface of the movable block, and the other side of the quick-mount seat may include a second inclined surface matching with the inclined surface of the locking block.

Further, in some embodiments, when the lever may be in the locked position, the movable block inclined surface and the first inclined surface may be in an overcut state.

Further, in some embodiments, one side of the movable block may protrude outward to facilitate exerting force on a pressing member of the movable block.

Further, in some embodiments, the base may include a threaded connection hole and a guide groove on one side facing the locking block. In some embodiments, one end of the tension rod may be threadedly connected to the threaded connection hole, and the locking block may include a guide column that matches a shape of the guide groove and may be slidably connected to the guide groove.

Further, in some embodiments, a reset spring elastically supported between the bottom of the guide groove and the guide column may be included in the guide groove, and when the lever is in the released position, the elastic force of the reset spring may drive the locking block to move in a direction away from the movable block.

Further, in some embodiments, the lever assembly also may include a lever shaft fixedly connected to the end of the tension rod. In some embodiments, one end of the lever shaft connected to the lever shaft may include an eccentric block, and the eccentric block may be rotatably connected to the lever shaft. In one aspect, when the lever shaft is in a disengaged state, a proximal end of the eccentric block may abut against the locking block; when the lever is in an engaged state, the distal end of the eccentric block may abut against the locking block.

Further, in some embodiments, the locking block may also include a receiving groove on one side facing the lever, and the lever assembly may also include a pressure block embedded in the receiving groove and sleeved on the outer periphery of the tension rod. In one aspect, the pressure block may be padded between the eccentric block of the lever and the locking block.

Further, in some embodiments, at least two elastic gaskets may be padded between the pressure block and the bottom of the receiving groove.

Furthermore, in some embodiments, a shaft hole may be included on the base, and both ends of the shaft may be fixed in the shaft hole. In some embodiments, a mounting groove may be included on the back of the base, and the shaft may pass through the mounting groove. In a further embodiment, a connecting hole may be included on the portion of the back of the base where the mounting groove is not provided. In some embodiments, a connecting screw for connecting to an external gimbal may be threadedly connected to the connecting hole.

For example, aspects of the invention may include one or more the following advantages:

In some embodiments, the quick-mount mechanism of the present invention may include a base, a movable block, a locking block, a quick-mount seat and a lever assembly. In some embodiments, the movable block and the locking block may be located on the opposite sides of the base, and the dovetail groove for locking the quick-mount seat may be formed by the movable block, the locking block and the base. In one embodiment, and the base may serve as the bottom wall of the dovetail groove, and the two opposite groove side walls of the dovetail groove are respectively formed by the movable block and the locking block. The movable block may be rotatably connected to one side of the base through a rotating shaft and a torsion spring. Due to the rotatable design of the movable block, the quick-mount seat can be quickly installed from top to bottom by pressing downward. In the dovetail groove; when locking the quick-mount seat, rotate the pull lever, and the pull lever pushes the locking block to move toward the movable block. The locking block and the movable block may cooperate to lock the quick-mount seat in the dovetail groove. In this quick-mount seat locking approach, for example, the locking force provided by the pull lever only needs to push the locking block to move. When the pull lever is rotated from the loose position to the locked position, the movement stroke along the tension rod is the movement stroke of the locking block. The locking force may be fully applied to the quick-mount seat through the locking block, which is beneficial to improve the locking effect of the quick-mount seat; and the overall structure is simple and has fewer parts, which is beneficial to reducing the production cost of the quick-mount mechanism.

### BRIEF DESCRIPTION OF THE DRAWINGS

In order to more clearly illustrate the specific embodiments of the present invention or the technical solution in the prior art, the following will briefly introduce the drawings required for the specific implementation or the prior art description. Obviously, the drawings described below are some implementations of the present invention. For those skilled in the art, other drawings may be obtained based on these drawings without creative work.

FIG. 1 is a schematic diagram of the three-dimensional structure of the quick-mount mechanism according to an embodiment of the present invention;

FIG. 2 is a schematic diagram of the structure of the base and the quick-mount seat before assembly according to an embodiment of the present invention;

FIG. 3 is a schematic diagram of the back structure of the base according to an embodiment of the present invention;

FIG. 4 is an exploded view of the quick-mount mechanism according to an embodiment of the present invention;

Reference number keys: 1. base; 11. shaft hole; 12. threaded connection hole; 13. guide groove; 1a. front; 1b. back; 2. movable block; 21. movable block inclined surface; 22. pressing member; 3. locking block; 31. locking block inclined surface; 32. guide column; 33. accommodating groove; 4. quick-mount seat; 41. first inclined surface; 42. second inclined surface; 5. lever assembly; 51. lever; 52. lever shaft; 53. tension rod; 54. pressure block; 55. elastic gasket; 6. reset spring; 7. shaft; 8. torsion spring; 9. connecting screw.

### DETAILED DESCRIPTION

The technical solution of the aspects of present invention will be described clearly and completely below in conjunction with the accompanying drawings. Obviously, the described embodiments are part of the embodiments of the present invention, not all of the embodiments. Based on the embodiments of the present invention, all other embodiments obtained by ordinary technicians in the field without creative work are within the scope of protection of the present invention.

In the description of the present invention, it should be noted that the orientation or position relationship indicated by the terms “center”, “up”, “down”, “left”, “right”, “vertical”, “horizontal”, “inside”, “outside”, etc. is based on the orientation or position relationship shown in the accompanying drawings, which is only for the convenience of describing the present invention and simplifying the description, rather than indicating or implying that the device or element referred to must have a specific orientation, be constructed and operated in a specific orientation, and therefore cannot be understood as a limitation of the present invention. In addition, the terms “first”, “second”, and “third” are only used for descriptive purposes and cannot be understood as indicating or implying relative importance.

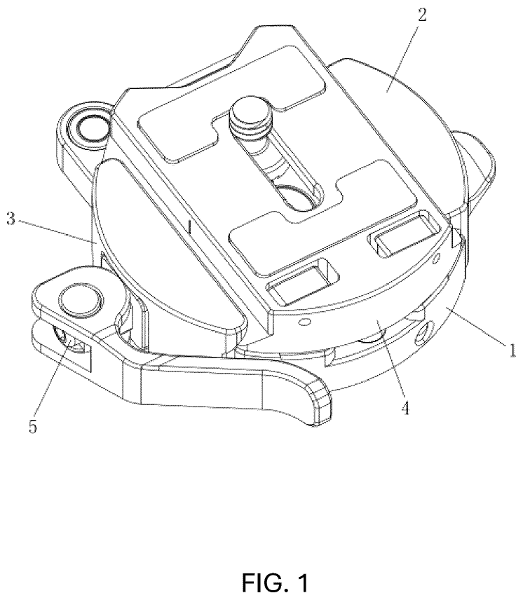

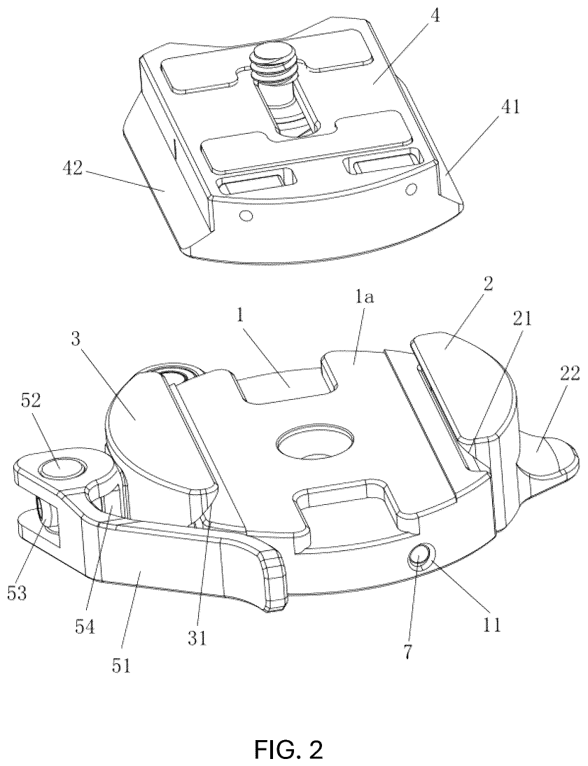

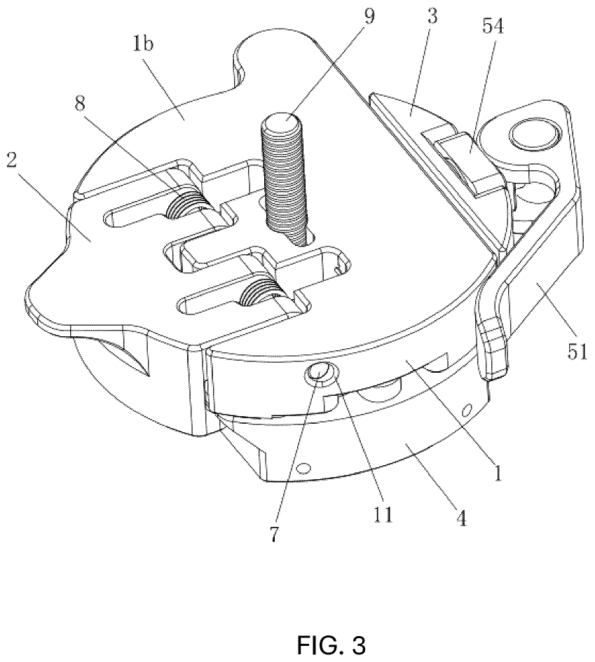

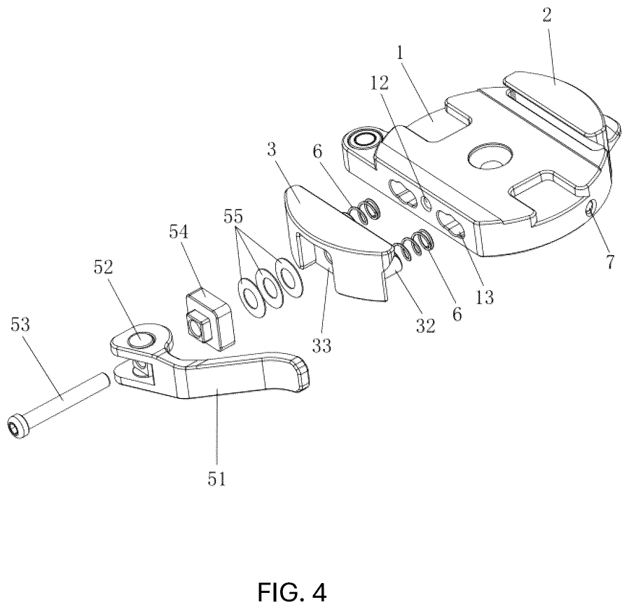

A quick-mount mechanism as shown in FIG. 1-4 according to embodiments

of the invention may include a base 1, a movable block 2, a locking block 3, a quick-mount seat 4 and a lever assembly 5. In one example, the base 1 may be a flat plate structure, and the base 1 comprises a front face 1a and a back face 1b arranged opposite to each other. in some embodiments, the movable block 2 and the locking block 3 may be respectively located on opposite sides of the base 1. In another aspect, the movable block 2 and the locking block 3 cooperate to enclose a dovetail groove on the front face 1a of the base 1. For example, the front face 1a of the base 1 may form the groove side wall of the dovetail groove, and the movable block 2 and the locking block 3 may form the groove side wall of the dovetail groove.

In one aspect, a rotating shaft 7 may be installed on the back face 1b of the base 1. In some embodiments, one end of the movable block 2 may be rotatably connected to the rotating shaft 7. In another example, a torsion spring 8 may be wound around the rotating shaft 7. In another embodiment, one end of the torsion spring 8 may abut against the base 1 and the other end may abut against the movable block 2. In another example, the elastic force of the torsion spring 8 may drive the movable block 2 to rotate in the direction of pressing the base 1. In some embodiments, the locking block 3 may be movably mounted on one side of the base 1 along the connection direction between the locking block 3 and the movable block 2, and the quick-mount seat 4 may be detachably connected to the dovetail groove. In one aspect, the lever assembly 5 may include a tension rod 53. In some embodiments, one end of the lever assembly 5 may be connected to the base 1 and may penetrate the locking block 3, and a lever 51. In one example, the lever 51 may be located on the side of the locking block 3 facing away from the base 1 and is rotatably connected to the end of the tension rod 53. In some embodiments, the lever 51 may include a locked position and a released position during rotation. When the lever 51 is in the released position, the quick-mount seat 4 may be pressed into the dovetail groove from the front side 1a of the base 1. When the lever 51 is in the locked position, the lever 51 may push the locking block 3 to move toward the movable block 2, so that the locking block 3 and the movable block 2 may cooperate to lock the quick-mount seat 4 in the dovetail groove.

In one embodiment, the movable block 2 may include a movable block inclined surface 21 forming one side wall of the dovetail groove, and the locking block 3 may include a locking block inclined surface 31 forming another side wall of the dovetail groove. In one aspect, one side of the quick-mount seat 4 may include a first inclined surface 41 that matches or corresponds to the inclined surface of the movable block inclined surface 21, and the other side of the quick-mount seat 4 may include a second inclined surface 42 that matches or corresponds to the inclined surface of the locking block inclined surface 31. During user's operation to lock the quick-mount seat 4, the lever 51 may drive the locking block 3 to move through the tension rod 53, and the locking block 3 pressing down the first inclined surface 41 on the quick-mount seat 4 through the locking block inclined surface 31, and cooperates with the movable block 2 to press the quick-mount seat 4 downward on the base 1. When the lever 51 is in the locked position, the movable block inclined surface 21 and the first inclined surface 41 may be in an overcut state.

In one embodiment, one side of the movable block 2 may protrude outward to facilitate pressing the pressing member 22 of the movable block 2.

In this embodiment, a threaded connection hole 12 and a guide groove 13 may be provided on the side of the base 1 facing the locking block 3. In one aspect, one end of the tension rod 53 may be threadedly fixedly connected to the threaded connection hole 12, and a guide column 32 matching the shape of the guide groove 13 and slidably connected in the guide groove 13 is provided on the locking block 3. In some embodiments, there may be two guide grooves 13, and there may also be two corresponding guide columns 32. In some embodiments, the two guide grooves 13 may be located on opposite sides of the threaded connection hole 12. In another embodiment, a reset spring 6 elastically supported between the bottom of the guide groove 13 and the guide column 32 may be disposed at each guide groove 13. In one aspect, when the lever 51 is in the released position, the elastic force of the reset spring 6 may drive the locking block 3 to move away from the movable block 2.

In this embodiment, the lever assembly 5 also may include a lever shaft 52 connected at the end of the tension rod 53. In one aspect, the end of the lever 51 connected to the lever shaft 52 may be an eccentric block, and the eccentric block may be rotatably connected to the lever shaft 52. In another example, when the lever 51 may be in a released state, the proximal end of the eccentric block abuts against the locking block 3. In another embodiment, when the lever 51 is in a locked state, the distal end of the eccentric block abuts against the locking block 3. In one aspect, the side of the locking block 3 facing the lever 51 may be of an arc surface. In order to facilitate the lever 51 to press the locking block 3, a receiving groove 33 may be disposed on the side of the locking block 3 facing the lever 51. In one example, the receiving groove 33 may be square in shape as a whole, and the bottom of the receiving groove 33 is a flat plane. In one aspect, the lever assembly 5 also may include a pressure block 54 embedded in the receiving groove 33 and may be sleeved on the outer periphery of the tension rod 53. In one example, the outer size of the pressure block 54 may be the same as the outer size of the receiving groove 33. The pressure block 54 may be padded between the eccentric block of the lever 51 and the locking block 3 to increase the pressure area of the locking block 3 to decrease the play of the locking block 3.

Furthermore, in some embodiments, three elastic gaskets may be included between the pressing block 54 and the bottom of the receiving groove 33. In one example, the three elastic gaskets may effectively eliminate the contact surface gap between the pressing block 54 and the locking block 3 by using their own elasticity and compressibility, so that the force of the pressing block 54 can be more smoothly transmitted to the locking block 3. It is to be understood that other amount of gaskets may be used for achieving the same purpose.

In some embodiments, a rotating shaft hole 11 may be disposed at the base 1, and both ends of the rotating shaft 7 are disposed in the rotating shaft hole 11. In one example, the back 1b of the base 1 may be provided with a mounting groove, and the rotating shaft 7 runs through the mounting groove, and the end of the movable block 2 connected to the rotating shaft 7 may fit within the mounting groove. In one aspect, the back 1b of the base 1 absent the mounting groove may be provided with a connecting hole, and the connecting hole is threadedly connected with a connecting screw 9 for connecting with an external pan or tilt head, if desirable. With such a design, since the structure of the base 1 is relatively simple and bare bone, there is no need to design a complex structure such as a sliding block inside the base 1. In some embodiments, the back 1b of the base 1 maintains a larger structural design space, so it is convenient to set a connecting screw 9 for connecting with with external pan or tilt head on the back 1b of the base 1, which may further enrich the use scenarios of the quick-mount mechanism.

In some embodiments, embodiments of the quick-mount mechanism may be used by the user according to the assembly process as follows: when installing the quick-mount seat 4, the lever 51 may be in the open or released state. The quick-mount seat 4 may be pressed down from top to bottom for installation. Once the quick-mount seat 4 rests on the movable block 2, the movable block 2 may rotate downward along the rotation axis 7 to a certain angle. In some embodiments, the movable block 2 may avoid the quick-mount seat 4, and the quick-mount seat 4 may be directly pressed down to the front side 1a of the base 1. At this time, the movable block 2 is freed from the pressure of the quick-mount seat 4, and the movable block 2 may rotate upward along the rotation axis 7 under the action of the torsion spring 8, and part of the movable block 2 may rotate to the top of the quick-mount seat 4. At this time, the user may apply force to close the lever 51, and the locking block 3 moves toward the movable block 2 under the action of the tension rod 53. Accordingly, the inclined surface 31 of the locking block may move close to the quick-mount seat 4. After the second inclined surface 42 of the quick-mount seat 4 comes into contact, the lever 51 may drive the quick-mount seat 4 to move toward the movable block 2 until the first inclined surface 41 of the quick-mount seat 4 is pressed tightly against the inclined surface 21 of the movable block. At this time, the locking block 3 may press against the quick-mount seat 4. When the movable block 2 is pressed downward again, the movable block inclined surface 21 of the movable block 2 and the first inclined surface 41 of the quick-mount seat 4 are in an overcut state, so the movable block 2 cannot be pressed downward. When releasing the quick-mount seat 4, it is only necessary to loosen the lever 51, and the locking block 3 moves in the direction away from the movable block 2 under the action of the return spring 6. When the movable block 2 is pressed downward (e.g., pressing on the pressing member 22), the inclined surface 21 of the movable block is disengaged from the first inclined surface 41 of the quick-mount seat 4, and the quick-mount seat 4 may be removed out from the bottom.

The quick-mount mechanism provided by the embodiments of the present invention locates the movable block 2 and the locking block 3 on opposite sides of the base 1. In one aspect, the dovetail groove for locking the quick-mount seat 4 may be formed by the movable block 2, the locking block 3 and the base 1. The base 1, in one example, may serve as the bottom wall of the dovetail groove. The two opposite groove side walls of the dovetail groove are respectively formed by the movable block 2 and the locking block 3. The movable block 2 may be rotatably connected to one side of the base 1 through the rotating shaft 7 and the torsion spring 8. Due to the rotatable combination design of the movable block 2, the quick-mount seat 4 may be quickly installed or mounted in the dovetail groove from top to bottom by pressing down toward the base 1. In some embodiments, when locking the quick-mount seat 4, the lever 51 is rotated or activated. In some embodiments, the lever 51 pushes the locking block 3 toward the movable block 2. The locking block 3 and the movable block 2 cooperate to lock the quick-mount seat 4 in the dovetail groove. In this locking method of the quick-mount seat 4, the locking force provided by the lever 51 only needs to push the locking block 3. When the lever 51 is rotated or activated from the released position to the locked position, the movement stroke along the tension rod 53 is the movement stroke of the locking block 3. The locking force may be fully applied to the quick-mount seat 4 through the locking block 3, which is beneficial to improving the locking effect of the quick-mount seat 4. In addition, the overall structure is simple and has fewer parts, which is beneficial to reducing the production cost of the quick-mount mechanism.

Obviously, the above embodiments are merely examples for the purpose of clear disclosure, and are not intended to limit the implementation. For those skilled in the art, other different forms of changes or modifications may be made based on the above description. It is not necessary and impossible to list all the implementation methods here. The obvious changes or modifications derived therefrom are still within the scope of protection of the invention.

What is claimed is:

1. A quick-mount mechanism comprising:
a base (1),
a movable block (2),
a locking block (3),
a quick-mount seat (4) and a lever assembly (5);
wherein the movable block (2) and the locking block (3) are respectively disposed on opposite sides of the base (1);
wherein the movable block (2) and the locking block (3) cooperate to form a dovetail groove on the front side (1a) of the base (1);
a rotating shaft (7) installed on the back side (1b) of the base (1);
wherein one end of the movable block (2) is rotatably connected to the rotating shaft (7);
a torsion spring (8) disposed around the rotating shaft (7);
one end of the torsion spring (8) abuts against the base (1) and the other end abuts against the movable block (2);
wherein an elastic force of the torsion spring (8) drives the movable block (2) to rotate in a direction of pressing the base (1);
wherein the locking block (3) is movably arranged along a connection direction between the locking block (3) and the movable block (2);
wherein the quick-release seat (4) is detachably mounted on one side of the base (1) and is detachably connected to the dovetail groove; and
wherein the lever assembly (5) comprises:
a tension rod (53) with one end connected to the base (1) and passing through the locking block (3), and
a lever (51) located on one side of the locking block (3) facing away from the base (1) and rotatably connected to the end of the tension rod (53);
wherein the lever (51) comprises a locked position and a released position;
in response to the lever (51) being in the release position, the quick-release seat (4) moves into the dovetail groove from the front side (1a) of the base (1); and
in response to the lever (51) being in the locked position, the lever (51) pushes the locking block (3) toward the movable block (2) and the quick-release seat (4) is locked in the dovetail groove.

2. The quick-mount mechanism according to claim 1, wherein the movable block (2) comprises a movable block inclined surface (21) forming one side wall of the dovetail groove, and the locking block (3) comprises a locking block inclined surface (31) forming the other side wall of the dovetail groove; wherein one side of the quick-mount seat (4) comprises a first inclined surface (41) matching with the inclined surface of the movable block inclined surface (21), and the other side of the quick-mount seat (4) comprises a second inclined surface (42) matching with the inclined surface of the locking block inclined surface (31).

3. The quick-mount mechanism according to claim 2, wherein, in response to the lever (51) being in the locked position, the movable block inclined surface (21) and the first inclined surface (41) are in an overcut state.

4. The quick-mount mechanism according to claim 1, wherein one side of the movable block (2) protrudes outward to facilitate pressing the pressing member (22) of the movable block (2).

5. The quick-mount mechanism according to claim 1, further comprising a threaded connection hole (12) and a guide groove (13) disposed on the side of the base (1) facing the locking block (3); wherein one end of the tension rod (53) is threadedly fixedly connected to the threaded connection hole (12), and the locking block (3) comprises a guide column (32) matching the shape of the guide groove (13) and slidably connected in the guide groove (13).

6. The quick-mount mechanism according to claim 5, further comprising a return spring (6) disposed in the guide groove (13) elastically supported between a bottom of the guide groove (13) and the guide column (32); wherein, in response to the lever (51) is in the released position, an elastic force of the return spring (6) drives the locking block (3) to move away from the movable block (2).

7. The quick-install mechanism according to claim 6, wherein the lever assembly (5) further comprises a lever shaft (52) connected to the end of the tension rod (53), wherein one end of the lever (51) connected to the lever shaft (52) comprises an eccentric block, and wherein the eccentric block is rotatably connected to the lever shaft (52);
in response to the lever (51) being in a released state, a proximal end of the eccentric block abuts against the locking block (3);
in response to the lever (51) being in a locked state, a distal end of the eccentric block abuts against the locking block (3).

8. The quick-mount mechanism according to claim 7, further comprising a receiving groove (33) disposed on the side of the locking block (3) facing the lever (51), and the lever assembly (5) further comprises a pressure block (54) embedded in the receiving groove (33) and sleeved on the outer periphery of the tension rod (53); wherein the pressure block (54) is padded between the eccentric block of the lever (51) and the locking block (3).

9. The quick-mount mechanism according to claim 8, wherein the pressure block (54) is padded with at least two elastic gaskets (55) between the pressure block (54) and a bottom of the receiving groove (33).

10. The quick-mount mechanism according to claim 1, further comprising a rotating shaft hole (11) disposed at the base (1), and both ends of the rotating shaft (7) are fixed in the rotating shaft hole (11);
further comprising a mounting groove disposed on the back side (1b) of the base (1), and the rotating shaft (7) passes through the mounting groove;
further comprising a connecting hole disposed on a portion of the back side (1b) of the base (1) where the mounting groove is absent, and
further comprising a connecting screw (9) for connecting to an external pan or tilt head for threadedly connected to the connecting hole.
